(19) United States
(12) Patent Application Publication
(10) Pub. No.: US 2009/0185710 A1
(43) Pub. Date: Jul. 23, 2009

(54) AUDIO SPEAKER

(76) Inventor: Szu-Wei Sun, Kueishan Shiang (TW)

Correspondence Address: NIKOLAI & MERSEREAU, P.A., 900 SECOND AVENUE SOUTH, SUITE 820, MINNEAPOLIS, MN, 55402, US

(21) Appl. No.: 12/015,704

(22) Filed: Jan. 17, 2008

(51) Int. Cl. H04R 1/00

(52) U.S. Cl. 381/413

(57) ABSTRACT

An audio speaker is implemented as a front or rear mounting type speaker. In one embodiment, the front mounting type speaker includes a U yoke; a frame mounted on the top periphery of the U yoke; a magnet secured onto the bottom of the U yoke; a pole piece mounted on the magnet; a voice coil mounted around the pole piece and spaced therefrom, the voice coil having a coil section and a non-coil section; a damper interconnecting an inner, intermediate stage of the frame and the non-coil section, an inner support mounted on an inner, upper stage of the frame; a diaphragm having an inner edge secured to the non-coil section above the damper; and a surrounding suspension member interconnecting the inner support and an outer edge of the diaphragm. The damper has a width equal to or greater than that of the suspension member in either type.

### BACKGROUND OF THE INVENTION

1. Field of Invention

The invention relates to audio speakers and more particularly to a front mounting type audio speaker having an inner support or a rear mounting type audio speaker manufactured by assembling two sub-assemblies together with improved characteristics including a maximized damper, a decreased lowest resonance frequency and improved performance.

2. Description of Related Art

A conventional audio speaker is shown in FIG. 6 and comprises a U yoke 30 as a base, a frame 31 mounted around on the top periphery of the U yoke 30, a permanent magnet 32 provided on a central portion of the bottom of the U yoke 30, a pole piece 33 provided on the permanent magnet 32, a voice coil 34 provided around the pole piece 33 and spaced therefrom by a predetermined distance, a damper 36 interconnecting an inner edge of the frame 31 and a portion of the voice coil 34 without coil 35 being mounted, and a cone 37 having an inner edge attached to the top of the voice coil 34 above the damper 36 and an outer edge 38 attached to the top edge of the frame 31.

The voice coil 34 vibrates laterally when the speaker activates. And in turn, the vibration is decreased in strength by both the edge 38 and the damper 36. Thus, the voice coil 34 is prevented from contacting the U yoke 30 or the permanent magnet 32.

However, the well known audio speaker suffers from several disadvantages. For example, the damper 36 is short. Also, width of the damper 36 is even shorter than that of the edge 38. As a result, a further reduction of lowest resonance frequency is made impossible and performance is degraded. Thus, it is desirable to provide a novel audio speaker in order to overcome the inadequacies of the prior art.

### SUMMARY OF THE INVENTION

It is therefore one object of the invention to provide a front mounting type audio speaker comprising a U yoke as a base; a frame mounted on the top periphery of the U yoke; a magnet secured onto the bottom of the U yoke; a pole piece mounted on the magnet; a voice coil mounted around the pole piece and spaced therefrom by a predetermined distance, the voice coil having a coil section and a non-coil section; a damper interconnecting an inner, intermediate stage of the frame and the non-coil section, an inner support mounted on an inner, upper stage of the frame; a diaphragm having an inner edge secured to the non-coil section above the damper; and a surrounding suspension member interconnecting the inner support and an outer edge of the diaphragm, wherein the damper has a width equal to or greater than that of the suspension member.

It is another object of the invention to provide a rear mounting type audio speaker comprising a first sub-assembly including a U yoke as a base, a lower frame member mounted on the top periphery of the U yoke, a magnet secured onto the bottom of the U yoke, a pole piece mounted on the magnet, a voice coil mounted around the pole piece and spaced therefrom by a predetermined distance, the voice coil having a coil section and a non-coil section, and a damper interconnecting an inner, upper flange of the lower frame member and the non-coil section; and a second sub-assembly including a diaphragm, an upper frame member, and a surrounding suspension member interconnecting an inner, lower flange of the upper frame member and an outer edge of the diaphragm, wherein the second sub-assembly is mounted on the first sub-assembly with the bottom of the upper frame member secured on the top of the lower frame member and an inner edge of the diaphragm attached to the non-coil section above the damper, and wherein the damper has a width equal to or greater than that of the suspension member.

The above and other objects, features and advantages of the invention will become apparent from the following detailed description taken with the accompanying drawings.

### BRIEF DESCRIPTION OF THE DRAWINGS

FIG. 1 schematically depicts a front mounting type audio speaker according to the invention;

FIG. 2 schematically depicts a rear mounting type audio speaker according to the invention;

FIG. 3 is a longitudinal sectional view of the front mounting type audio speaker of FIG. 1;

FIG. 4 is a longitudinal sectional view of the rear mounting type audio speaker of FIG. 2 prior to assembly;

FIG. 5 is a longitudinal sectional view of the rear mounting type audio speaker of FIG. 2 after assembly; and

FIG. 6 is a longitudinal sectional view of a conventional audio speaker.

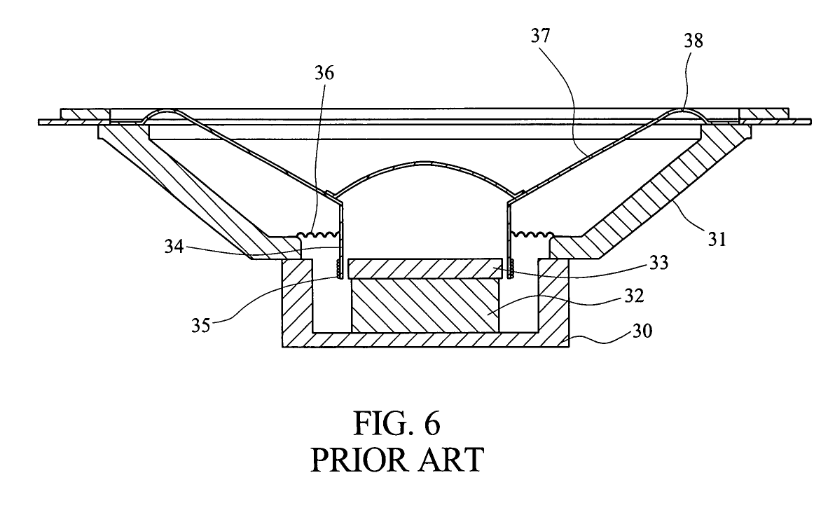

### DETAILED DESCRIPTION OF THE INVENTION

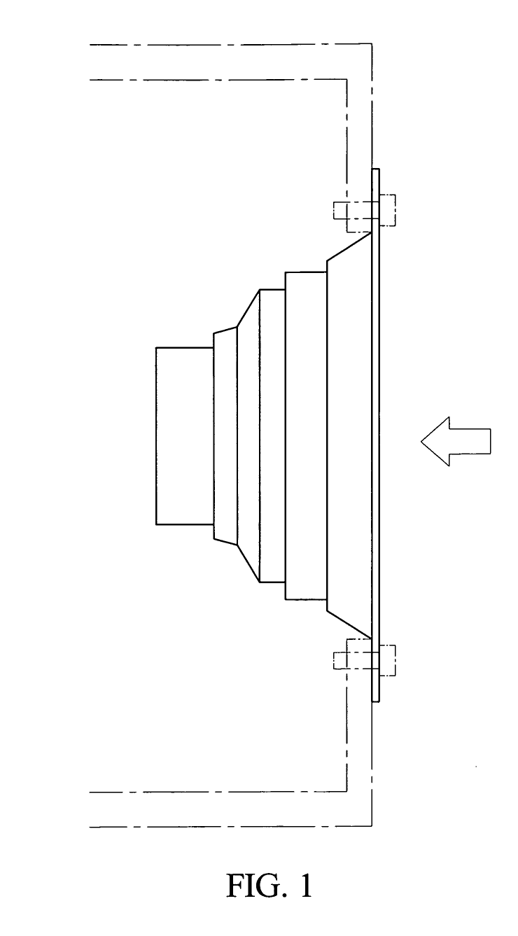

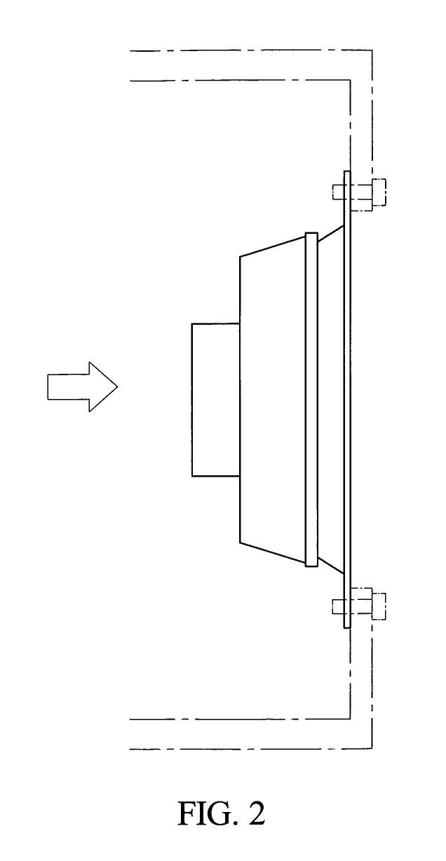

Referring to FIGS. 1 and 2, a front mounting type audio speaker and a rear mounting type audio speaker in accordance with the invention are shown respectively. A front mounting type audio speaker is characterized by having its components correctly mounted in the cabinet by means of supports, etc. Otherwise, an assembly of the front mounting type audio speaker may be made impossible. The rear mounting type audio speaker is characterized by without considering the orientation of the woofer and a maximized damper.

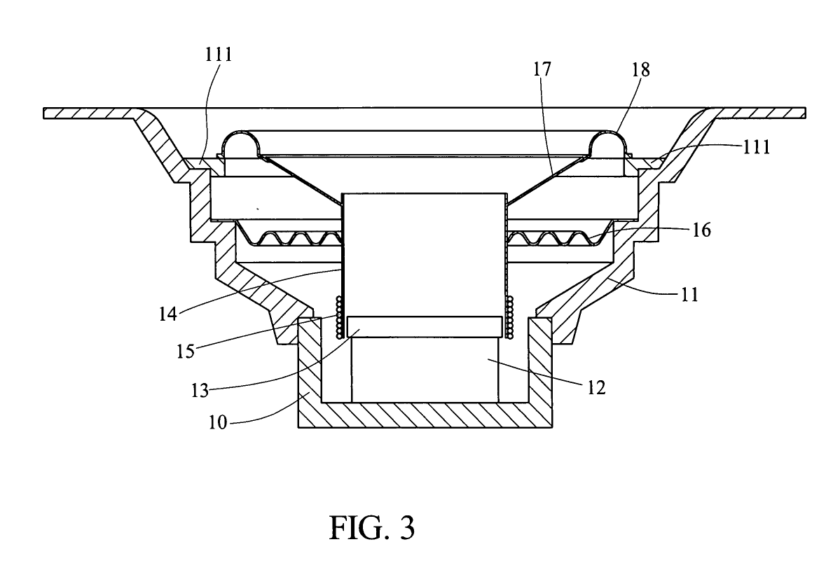

Referring to FIG. 3, a front mounting type audio speaker is shown. The speaker comprises a U yoke 10 as a base, a frame 11 mounted on the top periphery of the U yoke 10, a permanent magnet 12 provided on a central portion of the bottom of the U yoke 10, a pole piece 13 provided on the permanent magnet 12, a voice coil 14 provided around the pole piece 13 and spaced therefrom by a predetermined distance, a damper 16 interconnecting an inner, intermediate stage of the frame 11 and a portion of the voice coil 14 without coil 15 being mounted, and a cone 17 having an inner edge attached to the outer surface proximate the top of the voice coil 14 above the damper 16 and an outer edge attached to an edge (i.e., suspension member) 18 which is in turn attached to an inner support 111 on an inner, upper stage of the frame 11.

The characteristics of the front mounting type audio speaker are that the damper 16 has a width equal to or greater than that of the edge 18 and the edge 18 interconnects the cone 17 and the inner, upper stage of the frame 11. As a result, advantages including a maximized damper, a decreased lowest resonance frequency and improved performance are obtained.

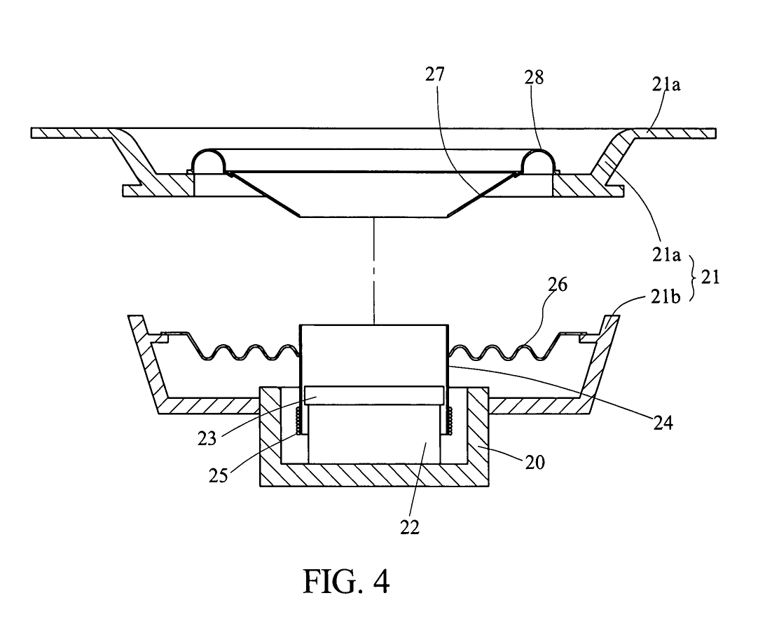

Referring to FIG. 4, a rear mounting type audio speaker is shown. The speaker comprises a first sub-assembly and a second sub-assembly secured together. The first sub-assembly comprises a U yoke 20 as a base, a lower frame member 21b mounted on the top periphery of the U yoke 20, a permanent magnet 22 provided on a central portion of the bottom of the U yoke 20, a pole piece 23 provided on the permanent magnet 22, a voice coil 24 provided around the pole piece 23 and spaced therefrom by a predetermined distance, and a damper 26 interconnecting an inner, upper flange of the lower frame member 21b and a portion of the voice coil 24 without coil 25 being mounted.

The second sub-assembly comprises a cone 27, an upper frame member 21a, and an edge (i.e., suspension member) 28 interconnecting an inner, lower flange of the upper frame member 21a and an outer edge of the cone 27.

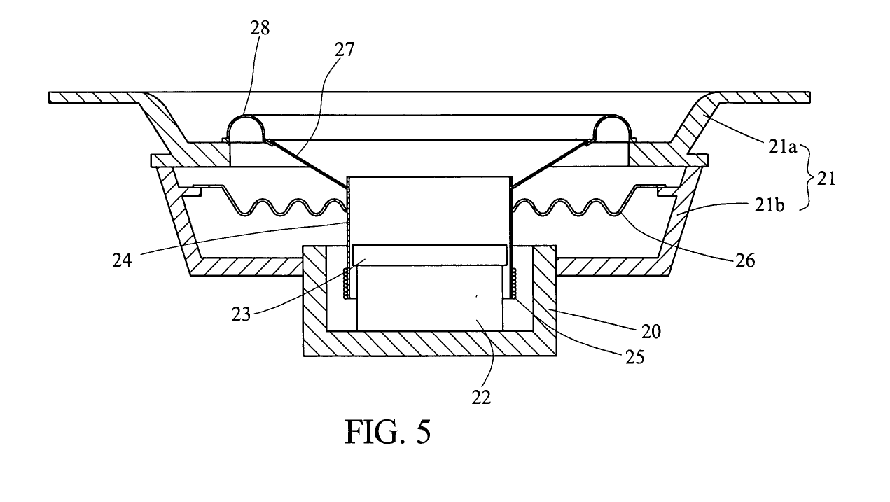

Referring to FIG. 5, the second sub-assembly is mounted on the first sub-assembly with the bottom of the upper frame member 21a secured on the top of the lower frame member 21b and the cone 27 having an inner edge attached to the outer surface proximate the top of the voice coil 24 above the damper 26. As a result, a complete rear mounting type audio speaker is produced.

The characteristics of the rear mounting type audio speaker are that the frame 21 consists of upper and lower frame members 21a, 21b and, the damper 26 has a width equal to or greater than that of the edge 28. As a result, advantages including a maximized damper, a decreased lowest resonance frequency and improved performance are obtained.

While the invention herein disclosed has been described by means of specific embodiments, numerous modifications and variations could be made thereto by those skilled in the art without departing from the scope and spirit of the invention set forth in the claims.

What is claimed is:

1. A front mounting type audio speaker comprising:
a U yoke as a base;
a frame mounted on the top periphery of the U yoke;
a magnet secured onto the bottom of the U yoke;
a pole piece mounted on the magnet;
a voice coil mounted around the pole piece and spaced therefrom by a predetermined distance, the voice coil having a coil section and a non-coil section;
a damper interconnecting an inner, intermediate stage of the frame and the non-coil section,
an inner support mounted on an inner, upper stage of the frame;
a diaphragm having an inner edge secured to the non-coil section above the damper; and
a surrounding suspension member interconnecting the inner support and an outer edge of the diaphragm,
wherein the damper has a width equal to or greater than that of the suspension member.

2. A rear mounting type audio speaker comprising:
a first sub-assembly including a U yoke as a base, a lower frame member mounted on the top periphery of the U yoke, a magnet secured onto the bottom of the U yoke, a pole piece mounted on the magnet, a voice coil mounted around the pole piece and spaced therefrom by a predetermined distance, the voice coil having a coil section and a non-coil section, and a damper interconnecting an inner, upper flange of the lower frame member and the non-coil section; and
a second sub-assembly including a diaphragm, an upper frame member, and a surrounding suspension member interconnecting an inner, lower flange of the upper frame member and an outer edge of the diaphragm,
wherein the second sub-assembly is mounted on the first sub-assembly with the bottom of the upper frame member secured on the top of the lower frame member and an inner edge of the diaphragm attached to the non-coil section above the damper, and
wherein the damper has a width equal to or greater than that of the suspension member.
